(19) United States
(12) Patent Application Publication
(10) Pub. No.: US 2006/0020638 A1
(43) Pub. Date: Jan. 26, 2006

(54) Method and apparatus to efficiently navigate and update a pointerless trie

(75) Inventor: Moshe Shadmon, Palo Alto, CA (US)

Correspondence Address: OLIFF & BERRIDGE, PLC, P.O. BOX 19928, ALEXANDRIA, VA, 22320, US

(73) Assignee: ORI SOFTWARE DEVELOPMENT LTD., Tel Aviv (IL)

(21) Appl. No.: 11/180,564

(22) Filed: Jul. 14, 2005

Related U.S. Application Data
(60) Provisional application No. 60/590,036, filed on Jul. 21, 2004.

(51) Int. Cl. G06F 17/30

(52) U.S. Cl. 707/200

(57) ABSTRACT

A computer program product that includes pointerless binary trie structure. The binary trie structure includes node elements representative of nodes of the trie. The structure further includes control elements that include information that facilitate traversal of the trie in a more efficient manner compared to traversal of pointerless binary trie structure that is devoid of the control elements.

### FIELD OF THE INVENTION

The invention is in the general field of databases, data management and index structures.

### BACKGROUND OF THE INVENTION

A trie is a data structure for representing sets of character strings that enables fast retrieval of the strings (indeed, the term is derived from retrieval). Although originally developed for character strings, it can also be applied to arbitrary binary strings. Each node in a trie represents the prefix of some subset of the strings indexed by the trie.

Tries can be described as structures that store strings by representing each character in the string as an edge on the path from the root to a leaf.

A Patricia trie (PT) is a simple form of compressed trie which merges single child nodes with their parents. Its name comes from the acronym PATRICIA, which stands for “Practical Algorithm to Retrieve Information Coded in Alphanumeric”, and was described in a paper published in 1968 by Donald R. Morrison (D. R. Morrison. “PATRICIA—Practical algorithm to retrieve information coded in alphanumeric.” ACM, 15 (1968) pp. 514-534).

Patricia Tries are a more compact form of tries that retain similar ability to search for strings. As described above, Patricia Trie is similar to a trie, except that nodes with only one child have been removed.

For an additional discussion on Patricia Trie, see Donald E. Knuth, The Art of Computer Programming, Volume 3/Sorting and Searching, page 490-499.

Tries are discussed, for example, in G. Wiederhold, “File organization for Database design”; Mcgraw-Hill, 1987, pp. 272, 273, or in D. E. Knuth, “The Art of Computer Programming”; Addison-Wesley Publishing Company, 1973, pp. 481-505, 681-687.

Since nodes with a single child are removed in PT, PT offers a high level of compression. However, PT is an unbalanced structure and therefore, it is mostly used as an in-memory structure. For example, PT is very popular for software implementations of the search task in routing tables to maintain the routing table within routers.

Lately it was suggested to use Patricia Tries for disk-based databases. This is done by partitioning a basic PT index into block-sized sub-tries. The blocks are indexed by a second trie, stored in its own block. This second trie was presented as a new horizontal layer, complementing the vertical structure of the original trie. If the new horizontal layer is too large to fit in a single disk block, it is split into two blocks, and indexed by a third horizontal layer (a detailed description of said process is available for example in U.S. Pat. No. 6,175,835 and B. Cooper, N. Sample, M. Franklin, G. Hijaltason, and M. Shadmon. A fast index for semi-structured data. In Proc. VLDB, 2001).

There are many methods to implement a trie and a PT (for example: Arne Andersson, Stefan Nilsson: Efficient Implementation of Suffix Trees. Softw., Pract. Exper. 25 (2): 129-141 (1995), or, Implementing a dynamic compressed trie. Stefan Nilsson and Matti Tikkanen. 2nd Workshop on Algorithm Engineering WAE '98, 1998).

The PhD thesis of Heping Shang: Trie Methods for Text and Spatial Data on Secondary Storage, McGill University 1994, presented trie organizations for binary tries including an organization that stored no pointers.

T. H. Merret, Jack Orenstein Heping Shang and Xiaoyan Zhao described how to make a pointerless representation of a binary trie—“Tries: a Data Structure for Secondary Storage”, October 1998. The idea with a pointerless representation is to achieve high level of compression. This makes the implemented trie smaller and impacts the performance of the systems using the trie. The larger an index, the more resources are needed to maintain the needed performance. For example, more memory is dedicated to efficient caching; more I/Os are potentially necessary to complete an operation etc.

In a binary trie, every node can have any one of four possibilities: A node may have two descendents, a left descendent only, a right descendent only and no descendent (which makes the latter a leaf). Since with a PT trie, nodes having only a single child are eliminated, every node of a binary PT may have two descendents or none.

An advantage of PT is that the amount of storage required for the trie is directly proportional to the number of strings and is independent of the lengths of the strings. In other words, a binary Patricia trie representing N strings has N-1 non-leaf nodes and 2(N-1) edges. When implemented, each node and edge require storage. If implemented such that the leaf nodes are maintained with the indexed data, each non-leaf node and edge require storage.

An implementation of a pointerless representation of a binary trie and a binary PT is space efficient. This stems from the fact that the pointerless implementation is implemented without physical pointers to represent the relations between the nodes (however, these relations can be determined from the ordering of the nodes). Therefore, the storage space for the edges is not required. Therefore, a pointerless implementation of a binary trie achieves high level of compression as the need for storage space for the edges is eliminated. With the pointerless implementations, the structure of the trie and the navigation in the trie are based on the organization and the order of the nodes.

However, such implementations suffer from poor performance in navigation, insert and delete operations compared to trie implementations that use pointers to represent the relations: With pointerless representation, the number of operations needed for navigating or operating on the trie, is much larger than the number of operations (for the same tasks) in a trie implemented with the physical pointers representing the relations. This stems from the fact that, with pointerless representation, the relations are calculated from the physical organization of the nodes, whereas with pointers representation, the organization is derived from the value of the pointers available in the implemented trie. In addition, pointerless implementation is characterized, in many cases, by massive reorganization of the data structure whenever update procedure (such as insert or delete) is performed. There is accordingly, a need in the art to provide for a technique that will allow a new implementation of a trie (such as a PT) with high performance on search insert and delete operations.

### LIST OF RELATED ART

| US PATENT # | TITLE |
|---|---|
| 1. 6,804,677 | Encoding semi-structured data for efficient search |
| | and browsing |
| 2. 6,675,173 | Database apparatus |
| 3. 6,240,418 | Database apparatus |
| 4. 6,208,993 | Method for organizing directories |
| 5. 6,175,835 | Layered index with a basic unbalanced partitioned |
| | index that allows a balanced structure of blocks |

### SUMMARY OF THE INVENTION

The present invention provides a computer program product that includes a pointerless binary trie structure; said trie structure includes elements representative of nodes of the trie; the structure further includes control elements that maintain information that facilitate traversal using the trie in a more efficient manner, compared to traversal using a pointerless binary trie structure that is devoid of the control elements.

The present invention further provides In a pointerless binary trie structure that includes node elements representative of nodes of the trie, a method for traversing the trie, comprising: (a) incorporating control elements in the trie; (b) traversing the trie using the control elements, thereby reducing the number of nodes that are visited compared to the number of nodes that need to be visited had pointerless binary trie structure that is devoid of control elements been used.

Further provided by the present invention is a computer program product that includes a pointerless binary trie structure; said binary trie structure includes node elements representative of nodes of the trie; said trie structure includes at least one control element that includes information that address at least one auxiliary structure; said auxiliary structure, together with an original pointerless implementation, reflect the structure of the original trie after having been subjected to one or more updates.

Further provided by the present invention is a computer program product that includes pointerless implementation of a binary trie; updates to the said trie are reflected by one or more auxiliary structures; if a disk block or memory page that stores the pointerless implementation together with the one or more auxiliary structures is full, a new pointerless trie is created; said new pointerless trie reflects the original trie with the relevant changes. Yet further provided by the present invention a computer program product that includes an index over keys of data records; said index is implemented based on a pointerless binary Patricia trie structure; said index includes an auxiliary structure that reflects updates to said index; said auxiliary structure is implemented with pointers.

The present invention further provides a computer program product that includes an index; the internal structure of the blocks of the said index is based on binary Patricia tries; the implementation of the trie within one or more blocks is of a pointerless trie; said pointerless trie includes control elements.

The present invention further provides a method for navigating in a binary Patricia trie; said trie is implemented as a pointerless trie; said pointerless trie includes one or more control elements; said control elements maintain information being used in the navigation process for efficiency.

The present invention provides in a pointerless binary Patricia trie structure that includes elements representative of nodes in the trie, a method for traversing the trie, comprising: (a) incorporating control elements in the trie; (b) traversing the trie using the control elements thereby reducing the number of nodes that are visited compared to the number of nodes that need to be visited using pointerless binary Patricia trie structure that is devoid of control elements.

The present invention further provides a computer program product that includes a pointerless binary Patricia trie structure; said trie structure includes elements representative of nodes of the trie; said trie structure includes at least one control element that included information that addresses respective auxiliary structures; said trie structure, together with the auxiliary structures, reflect the logical structure of the trie including the updates.

Further provided by the presnt invention a computer program product that includes a pointerless binary trie, said trie includes control elements; said control elements include additional information; said additional information obviates calculations that are performed during traversal of a pointerless binary trie without control elements.

### BRIEF DESCRIPTION OF THE DRAWINGS

For a better understanding, the invention will now be described, by way of example only, with reference to the accompanying drawings, in which:

FIG. 1 illustrates an exemplary binary PT structure over a set of keys;

FIG. 2 shows the structure of the trie of FIG. 1 after insertion of an additional key;

FIG. 3A illustrates an example of an implementation of a pointerless trie, in accordance with the prior art;

FIG. 3B illustrates the structure of an implementation of a pointerless trie after the insertion of an additional key, in accordance with the prior art;

FIG. 4A illustrates an implementation of a pointerless trie that was updated with a control element to locate an auxiliary structure, in accordance with an embodiment of the invention;

FIG. 4B illustrates an auxiliary structure representing the change in the trie after the insertion of an additional key, in accordance with an embodiment of the invention; and

FIG. 5 illustrates a logical relationship between the pointerless trie of FIG. 4A and the auxiliary structure of FIG. 4B.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as, “processing”, “computing”, “calculating”, “determining”, or the like, refer to the action and/or processes of a computer or computing system, or processor or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may use terms such as, processor, computer, apparatus, system, sub-system, module, unit and device (in single or plural form) for performing the operations herein. This may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes/devices (or counterpart terms specified above) and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

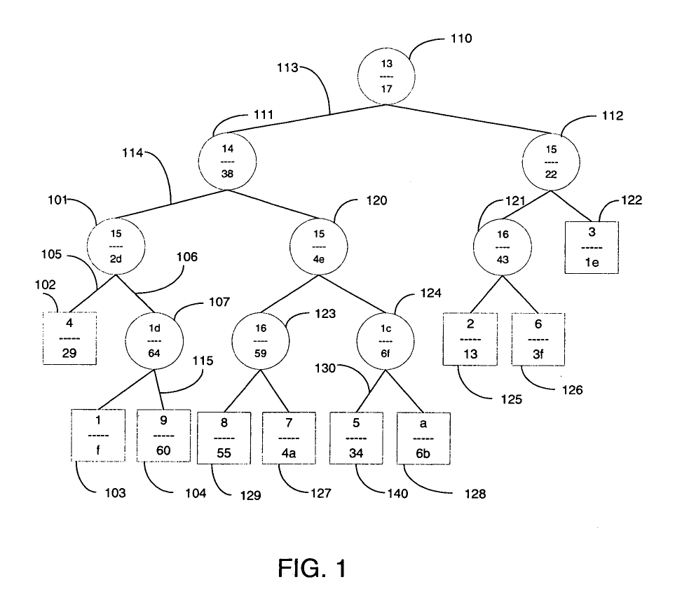

Bearing this in mind, attention is drawn to FIG. 1 illustrating an exemplary binary PT structure over a set of the following 10 keys:
1. Fiat
2. Pinto
3. Thing
4. Bug
5. Newport
6. Rangerover
7. Jeep
8. Hummer
9. Ford
10. Nissan

For the following example, each key is prefixed with a designator. A designator is an identifier to the type of information that makes part of the key. A detailed description of designators is available, for example, at: U.S. Pat. No. 6,175,835 and B. Cooper, N. Sample, M. Franklin, G. Hjaltason, and M. Shadmon. A fast index for semi-structured data. In Proc. VLDB, 2001, which is incorporated herein by reference.

Below is the list of 10 keys with the designators. For convenience, the designators are presented in hexadecimal and the rest of each key value is represented by the characters forming the rest of the key string. Each string may optionally be suffixed with additional values (such as nulls). These are not shown as they do not affect the structure of the trie for this particular example. The space between the designator's units and the space before the value after the designator are for convenience only.
1. 0x00 0x01 Fiat
2. 0x00 0x01 Pinto
3. 0x00 0x01 Thing
4. 0x00 0x01 Bug
5. 0x00 0x01 Newport
6. 0x00 0x01 Rangerover
7. 0x00 0x01 Jeep
8. 0x00 0x01 Hummer
9. 0x00 0x01 Ford
10. 0x00 0x01 Nissan

In this particular example, each key is prefixed with a 2 bytes designator having the value 0x0001 (Hexadecimal notation) representing data of the type—cars. Hence the designator forms part of the key, e.g. the first bytes of key #1 are: 0x00, 0x01, 0x46, 0x69, 0x6 1, 0x74 (and the rest can be set with nulls). (Byte 1 and byte 2 make the designator, byte 3 maintains the value 0x46 standing for the value ‘F’, byte 4 maintains the value 0x69 standing for the value ‘i’, byte 5 maintains the value 0x61 standing for the value ‘a’, and byte 6 maintains the value 0x74 standing for the value ‘t’).

FIG. 1 further shows a non-limiting example of an implementation of the PT trie structure, as is generally known per se. The trie of FIG. 1 is stored within a block (which may be a disk based block or a memory page). Every circle represents a non-leaf node wherein the top number within each circle represents the node value. The node value represents the size of the prefix, which is shared by all the keys that are children of the particular node. This value is independent of the implementation and depends only on the value of the keys being indexed. The bottom number is the position within the block where the node information is stored. This value is completely dependent on the implementation.

In the example of FIG. 1, the top number of node 101 is 0x15, representing the size (in bits) of the key shared by all the keys represented by the sub-trie rooted by node 101. The bottom number of node 101 is 0x2d (hexadecimal notation) representing a position (within the block where the trie of FIG. 1 is stored) where the information about node 101 is stored.

The squares represent leaf nodes, which are, in this particular example, links to the keys, which may be stored within the block or elsewhere. In this example, these keys are stored in a data file wherein the top number within each square represents a logical key number and the bottom number represents the storage location in the block of the logical key number. This implementation assumes that the key value can be retrieved once the logical key is available. In a different implementation, the trie maintains the key itself (the information in a leaf node includes the key value), or, physical address of the key in a file, or, the physical address of a data item from which the key can be derived, or any other identifier that would be sufficient to retrieve or create the key. In the example of FIG. 1, the top number of square 129 has the value 0x8, representing a car of type “Hummer” (positioned 0x8 in the list of cars above). The bottom number of square 129 has the value 0x55 meaning that this car identifier is stored at position 0x55 in the block. Both, the identifier from which the key is derived and the position where the identifier is stored, depend on the particular implementation.

In the example, as the prefix size (in bits) represented by node 101 is 0x15 (all numbers in the figures are in Hexadecimal notation), the size (in bits) of the shared (common) prefix of the keys ‘Bug’ (102), ‘Fiat’ (103) and ‘Ford’ (104) (with the appended 2 byte designator 0x0001) is 0x15.

The comparison of the prefixes of these keys, shows that the first 0x15 bit positions (including the designators) for these keys are identical:

The binary prefix for Bug is: 0000 0000 0000 0001 0100 0010

The binary prefix for Fiat is: 0000 0000 0000 0001 0100 0110

The binary prefix for Ford is: 0000 0000 0000 0001 0100 0110

As the common prefix is therefore: 0000 0000 0000 0001 0100 0 (and is 21 (0x15) bits long).

With the Patricia based trie, every non-leaf node maintains two edges represented by a left link and a right link.

For example, the left link of node 101 is 105 and the right link is 106. The links differentiate between the keys such that all the keys that are children of a particular node by a left link have the value 0 at the bit position after the common prefix. In the same manner, all the keys that are children of a particular node by a right link have the value 1 at the bit position after the common prefix. In the example of FIG. 1, link 105 leads to the key ‘Bug’ (represented by the leaf node 102) which has a bit value 0 at position 0x15 (considering the first bit of the key to be at position 0), and link 106 leads to the keys ‘Fiat’ (103) and ‘Ford’ (104), both with the value 1 at bit position 0x15.

In addition, the nodes can (optionally) store additional information. For example, (in a way of a non-limiting example), any n bits of the suffix of the common key prefix. In the particular example of FIG. 1, node 101 can store the 4 bits 1000 which are the last 4 bits of the shared prefix (positions 0x11, 0x12, 0x13 and 0x14 of the common key of keys 102, 103 and 104).

In this example implementation, the information stored with every non-leaf node (shown as a circle), includes the position of the immediate children nodes (or the position where the logical key value is stored—shown as a square).

For example, the information with node 101 (stored starting at position 0x2d in the tree storage space) includes also the value 0x29, standing for the location where information represented by square 102 is stored and the value 0x64, standing for the location of the information represented by the circle 107.

The FIG. 1 exemplified an implementation of a trie with pointers information. To navigate in such trie, one needs to start at the root node (which can, for example, be in a fixed position, or stored in the header of the block). From each node, it is possible to navigate left or right by retrieving the value of the relevant pointer to the next immediate child (in this example the left pointer value is prefixed to the node information and the right pointer value is prefixed to the left pointer information).

A typical navigation would use a search key to decide on the pointer to use. A left pointer would be used if the bit value of the search key (at bit position n where n is the node value) is 0, and a right pointer if the value is 1. Note that the structure of the trie according to FIG. 1 and the navigation through the trie, is generally known per se.

As explained (for example in T. H. Merret, Jack Orenstein Heping Shang and Xiaoyan Zhao “Tries: a Data Structure for Secondary Storage”), it is possible to implement a binary trie without the internal pointers (such as 105 and 106 of FIG. 1) and therefore compress the actual space needed to physically maintain and store any particular binary trie.

Using the pointerless approach, the PT of FIG. 1 can be stored as the following sequence (spaces, line breaks, line numbers and star signs are added for reading convenience only. The following structure is implemented as a series of bits representing the (hexa-decimal) values: 0x01, 0x13, 0x01, 0x014, 0x01, 0x015, 0x01, 0x015, . . . ):
1. 0x01 0x13
2. 0x01 0x14* 0x01 0x15
3. 0x01 0x15* 0x01 0x15*0x01 0x16*0x02 0x03
4. 0x02 0x04*0x01 0x1d*0x01 0x16*0x01 0x1c*0x02 0x02*0x02 0x06
5. 0x02 0x01*0x02 0x09*0x02 0x08*0x02 0x07*0x02 0x05*0x02 0x0a

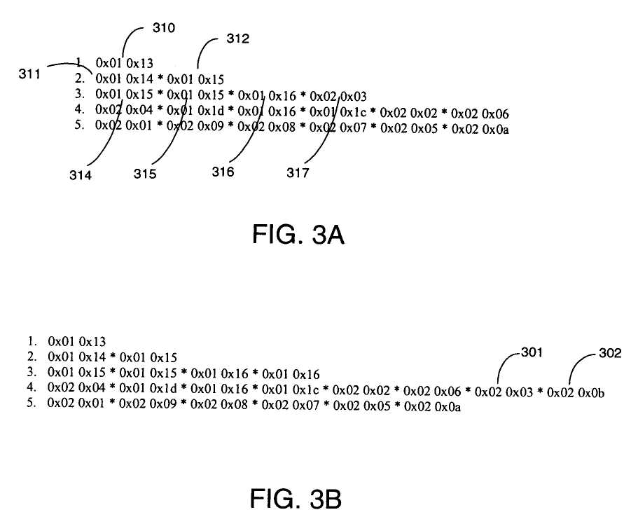

The above sequence is also presented in FIG. 3A, all as generally known per se. There are other ways that can be used to represent the structure of FIG. 1 without pointers. For example, by way of non-limiting example, it is possible to use depth first to present the following structure:
1,1,1,0,1,0,0,1,1,0,0,1,0,0,1,1,0,0,0

In the sequence above, the node values and key identifiers were omitted for simplicity, whereas 1 represents a non-leaf node and 0 represents a leaf node. The sequence above represents the trie structure of FIG. 1 by following the nodes in a particular predefined order (depth first), and therefore allows to construct the trie (the sequence correlates to the following traversal order over the trie of FIG. 1: 10, 111, 101, 102, 107, 103, 104, 120, 123, 129 127 124, 140, 128, 112, 121, 125, 126, 122).

The examples below relate to pointerless trie that is based on layer organization, however, those skilled in the art would be able to apply the techniques demonstrated below to different organizations of a pointerless trie.

For the discussion below, the tree of FIG. 1 represents nodes in different layers. The node 110 is the root node and therefore considered to be in layer 1 of the tree. Its relevant information is presented in line 1 above.

Nodes 111 and 112 are the immediate children of node 110 and therefore are considered to be in the second layer. The nodes of the second layer are presented in line 2 above. In the same manner, lines 3, 4 and 5 show the nodes of layer 3, 4 and 5, respectively.

In the above sequence, line 1 represents the root node (110) of the trie of FIG. 1: The first byte in line 1 stands for the type of information to follow: 0x01 marks non-leaf node information (for a standard binary trie the type can determine if the non-leaf node has a left child, a right child or both). The next byte represents the node value (0x13 for node 110).

The information can include additional information and may be organized in many different ways. For example, byte 1 can potentially hold information such as the number of bytes used to store the information related to node 110. Another implementation would add the last 4 bits of the shared prefix. Thus line 1 could be of the form:
1. 0x14 0x13 0x00 0x0a

Whereas, the first 4 bits represent the type of information. Their value is 1 and therefore node 110 by this example is a non-leaf node.

The next 4 bits store the value 4 standing for the number of bytes used to store the information relating to node 110. Therefore, if the size to hold information for nodes varies among the nodes, and as the tree appears as a sequence of bits, it is possible to differentiate between the elements by their size. Byte 2 stores the node value (0x13), the last 4 bits of byte 4 store the value 0x0a, which is the last 4 bits of the shared prefix (binary 1010 for key positions 0x0f to 0x12). Byte 3 is not being used in this example.

If the trie of FIG. 1 was a regular trie (rather than a PT), byte 3 could have been used to mark the children to node 110. For example, byte 3 could be used to specify 1 or 2 children and in case of a single child, the link to the child (0 for left child or 1 for a right child). However, since the trie of FIG. 1 is a binary PT, and node 110 is marked (by the type 1) as a non-leaf node, it can be predicted without additional information that node 1 maintains 2 links. Therefore, when traversing the trie, one could understand that the trie includes at least one additional layer and calculates that the next sequenced element is the left child 111, and the element afterwards is the right child 112.

The node elements marked with type 2 (such as element 102—the first element in layer 4, shown first in line 4 above) is a leaf node and therefore one can predict that it would not have children in the next layer. Therefore, a search may end at that leaf. For example, once node 102 is found, the search ends (or by another example, node 102. maintains the information where the key is stored and the search ends once the key or the data is retrieved using the identifier contained in the node information).

It should also be noted that additional information can be added to the tree and may (or not) be used by the search procedure. For example, U.S. Pat. No. 6,175,835 showed the use of a layered index. A particular implementation of the layered index was based on layers of tries (layers 1 . . . k . . . n), each trie layer was partitioned into disk based blocks. The layer 1 indexed the data records, and each other k layer indexed the common keys of the blocks of layer k-1. The storage size of the index of layer n could fit into a single disk based block. A search started at layer n and ended at layer 1 (or at the data record), wherein the implementation within each block was based on a trie. The particular example introduced direct links which were additional information stored with the trie. A pointerless implementation may add direct links to the tree information (A direct link from a particular node to a block of the next layer can be added to the information of the relevant nodes of the pointerless implementation).

If the n bits values are added to the trie, the search or traversals procedures may also consider these n bit key values (as well as the direct links if available). These bits, if stored for some or all the nodes in the trie, represent, as explained above, portion of the common key, whereas the node value relates to the position of the bits within the common key. Thus, during a tree traversal, this comparison (of the n bits in the tree to the relevant n bits in the search key) can make the traversal more efficient. For example, the comparison can show that a key does not exist within any of the children of a particular node. Or, as explained in great detail in the patent, if the bits do not do much, a new search may be initiated.

From the explanations above, it is seen that, although the pointerless trie is more efficient in size, the implementation with the pointers would be more efficient for traversal:

As every node includes the pointers information, it is possible to move from a node to any of the immediate children. For example, to navigate from node 120 of FIG. 1 to its right child (124), if the pointers are available, it is possible to use the pointer value 0x6f (this pointer value is the address of the right child 124—as seen under the dashed line in node 124 of FIG. 1) to find the needed node (124). However, if the pointers are not available, it is needed to calculate the position of the needed child. For example:

With reference to FIG. 3A, the information in layer 1 is of the root node maintaining the value 0x01 and 0x13 (310 in FIG. 3A representing node 110 of FIG. 1). As the root node is not a leaf (the type 0x01 determines a non-leaf node), it has two immediate children. From the root, the immediate children are the next 2 elements in the structure (the left child is the first in layer 2 and the right child is the second in layer 2—311 and 312 respectively and representing nodes 111 and 112 of FIG. 1). To continue the traversal from the root to the right child (312), it is needed to skip over the first element in layer 2 (311). To navigate to any of the next immediate children of 312, it is needed to determine that node 311 is not a leaf, therefore it has two children (314 and 315) and therefore, from the starting position of layer 3, skipping 2 elements (314 and 315) allows to visit the left child (316). In order to visit the right child 317 of node 312, 3 elements (314, 315, 316) are skipped. This is a much more complicated process than the process with a trie, where pointers are maintained explicitly and navigation from a node to a child involves moving to the child using explicit and readily available pointer data.

Having described certain known per se trie pointerless implementations, there follows a description with reference to a certain aspect of the invention which concerns incorporation of control information into the pointerless implementation which, as will be explained in greater detail below, expedites the navigation procedure through the trie.

Below is an example of additional information added to a pointerless implementation. The information is added to make the sequence more efficient for search and update as the added information will make the structure more efficient for traversal.

In accordance with certain embodiments, a control element is added to indicate the number of elements in every layer of the tree (and therefore to make the search more efficient as this information becomes readily available and does not have to be calculated). Example of such sequence representing the trie of FIG. 1 is as follows:
1. 0x31*0x01 0x13
2. 0x32*0x01 0x14*0x01 0x15
3. 0x34*0x01 0x15*0x01 0x15*0x01 0x16*0x02 0x03
4. 0x36*0x02 0x04*0x01 0x1d*0x01 0x16*0x01 0x1c*0x02 0x02*0x02 0x06
5. 0x36*0x02 0x01*0x02 0x09*0x02 0x08*0x02 0x07*0x02 0x05*0x02 0x0a

For example, the first number in line 2 is 0x32 whereas 3 stands for control number and 2 stands for the number of elements in the second layer of the trie (elements 111 and 112 of FIG. 1). It should be noted that this additional information is optional. As demonstrated above, it is possible to calculate this information “on the fly” during a traversal process.

In this manner, with reference to the structure above and FIG. 1, to search for the designated key ‘Ford’ (104), the following process is used:
1. Starting at the root node at line 1 above (logically node 110 of FIG. 1).
2. Since the value of the root node is 0x13, calculating the bit value at bit position 0x13 (of the search key: 0x00 0x01+“Ford”) to be 0 (the search key in binary format starts with 0000 0000 0000 0001 0100 0110 having 0 at position 0x13), and therefore deciding to traverse to the left child (node 111 of FIG. 1).
3. Finding by the control element at line #1 (shown above) that this layer of the tree has only a single element (node 110), and therefore the next sequential node element is the left child (node 111).
4. Since the value of node 111 is 0x14, calculating the bit value at bit position 0x14 (of the key: 0x00 0x01+“Ford) to be 0, and therefore deciding to traverse to the left child (node 101).
5. Finding by the control element at line #2 that this layer of the tree stores two elements (nodes 111 and 112), and therefore it is possible to skip over these nodes to the first sequential node element in line #3 (node 101).
6. Since the value of node 101 is 0x15, calculating the bit value at bit position 0x15 (of the key: 0x00 0x01+“Ford) to be 1, and therefore deciding to traverse to the right node (node 107).
7. Finding by the control element at line #3 that this layer of the tree stores four elements (nodes 101, 120, 121 and 122), and therefore it is possible to skip over these nodes to the beginning of layer 4 and to the second sequential node element in line #4 (node 107). The target is the second and not the first element in line 4, since the right child (107) of node (101) is of interest. If the left child (102) would be of interest, then the first element (rather than the second) in line 4 would be sought.
8. Since the value of node 107 is 0x1d, calculating the bit value at bit position 0x1d (of the key: 0x00 0x01+“Ford) to be 1, and therefore deciding to traverse to the right child (node 104).
9. Finding by the control element at line #4 that this layer of the tree stores six elements (nodes 102, 107, 123, 124, 125 and 126), and therefore it is possible to skip over these nodes to find the first element of layer 5 of the tree.
10. Since the node 102 is a leaf node (without children), the first element of layer #5 is the left child of node 107. And since the right child is needed, the search ends at the second element of layer #5 (104 of FIG. 1), which includes the key information or by another non-limiting example, the information where the key is stored.

An assumption in the above procedure is that nodes in the tree are of fixed size. Therefore, when it was needed to move from one layer to another, the control element allowed calculating the position of the next layer. For example, the traversal from element 107 to element 104 of FIG. 1 made use of the control element 0x36 (first element in line 4 above) to know that the first element of layer 5 is positioned 12 bytes away from the control element of line 4 (6—taken from the control element—multiplied by 2—the size of nodes in the structure). This allowed to navigate directly to the first element in layer 5, rather than scan through elements 123 124, 125 and 126 to find the first element in layer 5 and therefore to make the above search procedure more efficient.

In different embodiments, different implementations of the control elements are possible. For example, if the size of the nodes varies, the control element can include the position of the information of the next layer rather than (or in addition to) the number of nodes.

The traversal procedure exemplified above is based on the sequential ordering of the elements. The traversal procedure of the above example starts at the root node and ends in a leaf node. The procedure for each node includes a calculation based on the node value, to find the link to use (i.e. whether to move to the left child or the right child, if any). Once decided whether to move to the left direction or right direction, it is possible to find the child node. Finding a child node involves the process of finding the position of the layer that includes the child node. The process further determines the position of the child within each layer.

If a node is the n (th) node element in a particular layer of the tree, scanning over the n-1 previous elements in that layer allows to calculate the number of children to these previous elements and therefore to calculate the position, in the next layer of the tree, of the searched child.

The above example showed a search process in a pointerless implementation of a binary trie (in this particular example in a binary PT). The additional information of the control elements made the search more efficient as some of the information (in the example process above, information allowing the move from one layer to the next) was pre-calculated. In other words, the need to calculate how many elements reside in a given layer in order to move to the next layer is obviated.

In accordance with certain other embodiments, different control information is added. This control information can be in addition or instead of the specified control information.

Below is an example of additional information added to accelerate the traversal process of a pointerless implementation:

In this example control, elements are added every n element within each layer. The control elements indicate the position of the next control element, and the number of children to the node elements between a control element and the next control element.

With reference to the example of FIG. 1 (representing again the logical structure of the trie), and assuming that such control element was added for every two elements in each layer. For example, layer 4 of the pointerless implementation (which as recalled accommodates nodes 102, 107, 123, 124, 125 and 126), may be as follows (for convenience, the following notations were used: each element is stored at a separate line, each line number represent the element sequence number within the layer, node elements are intend, the node numbers in brackets are for convenience, representing the nodes in FIG. 1):
1. 0x03 0x42
2. 0x02 0x04 (node 102)
3. 0x01 0x1d (node 107)
4. 0x05 0x44
5. 0x01 0x16 (node 123)
6. 0x01 0x1c (node 124)
7. 0x05 0x40
8. 0x02 0x02 (node 125)
9. 0x02 0x06 (node 126)

The added information would accelerate the search as less “on the fly” calculations and data scanning are needed:

Assuming that the search has reached node 124 and now it is required to navigate to the left child of node 124 (using link 130), it is needed to calculate the number of children to the previously sequenced node elements in layer 4. This can be done by scanning through these elements and calculating (while scanning and inspecting—“on the fly”) 0 children for a leaf and 2 children for a non-leaf. Thus the scan through element 102 shows 0 children (element type 2), and the scan through 107 and 123 shows 2 children for each (elements of type 1), thus being able to calculate 4 children in layer 5 before the left child of element 124 is encountered. In addition, the process needs to find the position of the first element of layer 5.

With the additional information presented above, the process becomes more efficient:

Each control element maintains a type such that the value 3 represents the first control element within a layer (as exemplified by the first byte in line 1 above). Thus, the value 0x03 0x42 (in line 1) is the value of the first control element in layer 4 and it precedes the value 0x02 0x04 in line 2, which is indicative of the first node in layer 4 (node 102).

The value 0x05 of the control element marks a control element not being first in layer (such as the first byte in lines 4 and 7 above which precede nodes 123 and 125). The control elements include an additional byte with two pieces of information: a) number of bytes to skip to find the next control element and b) number of children to the nodes between the control element and the next control element.

For a better understanding of the foregoing, attention is drawn again to the traversal to the left child of node 124. The scanning through elements 102 and 107 to find the number of children is obviated as the information is stored in the control element shown in line 1 above (4 lower bits of the second byte)—to be 2. More specifically, this means that the number of children to nodes between the neighboring control elements is 2. In the latter example, the nodes between the control elements at line 1 (that precedes node 102) and the next control element (in line 4) that precedes node 123, are nodes 102 and 107. However, node 102 is a leaf node without children, whereas node 107 is a non-leaf node with 2 children (nodes 103 and 104).

Since the intention is to calculate the position of the left child of node 124, and since the control element in line 1 maintained the number of children to elements 102 and 107, the process then moves to inspect the next node element 123. First, the location of element 123 is determined using the information in the control element of line 1 (using the information in the high 4 bits of the second byte of the control element)—being 4 bytes away from the first control element, thus skipping over the four bytes in lines 2 and 3 above (representing nodes 102 and 107) to node 123. Then, only node 123 is examined (line 5 above) to find that this is a non-leaf node (having 2 children) and therefore, the number of node elements in layer 5, before the left child of 124, are 4. The above process demonstrated that the traversal from node 124 includes calculating the number of children to nodes 102, 107 and 123. The information within the first control element of layer 4 includes the number of children to the first 2 nodes in the layer (102 and 107) as well as the position of the next control element. Therefore the traversal process was performed without the inspection of elements 102 and 107 and only node 123 was inspected. The number of children to elements 102 and 107 was determined from the control element in line 1 (to be 2) and therefore the efficiency compared to the need to inspect the elements 102 and 107 (if the information relating to the number of children was not available in the control element of line 1). Element 123 was inspected to determine 2 children and therefore the number of elements in layer 5 proceeding the first child of node 124 are 4. The search continues to find the next control element (shown in line 7 above) from which the first control element of layer 5 (not shown) is found (using the information in the control element of line 7 to skip over 4 bytes, thus eliminating the need to scan through elements 125 and 126, to find the next control element which would be of type 3, being the first control element in the 5th layer).

In the same manner, the control elements in layer 5 would allow to skip every 2 elements to find the 5^{th} element (left child) of node 124.

The savings in the traversal process become apparent when considering large trees. Suppose that a particular layer has 100 node elements. Rather than scanning through the elements to calculate the number of children to be skipped (in the next layer) and to find the start position of the next layer, control elements every, say 10 elements, would allow to do the same process using pre-calculated information (as exemplified above). The traversal process would only inspect information in the control elements (and there are 10 control elements in the particular layer) and inspecting (only once) nodes between 2 consecutive control elements (10 nodes). This process includes calculation of at the most 20 elements (10 control elements and 10 node elements), rather than 100 node elements that exist in such layer.

It should also be noted that such additional information has a very minor impact on the overall size of the tree.

It should be also noted that the information within the control elements depends on the implementation.

In a different non-limiting example, the control element includes the position of the next control element (rather than the number of elements to skip) supporting a structure where the size of the nodes is not fixed. Note that the invention is not bound by the number of control elements, their locations, the types of the control elements and the information being included in the control elements.

In a binary PT implementation, representing N strings, 2(N-1) edges are maintained and stored. The pointerless implementation saves the storage of these edges. The additional control information as presented above, adds a small overhead (in the example above 2 bytes for every 10 nodes) to allow efficient search.

The above procedure demonstrated a traversal process in a pointerless trie implementation. Said implementation includes control elements with information that can be used to reduce the number of calculations done in said traversal process (compared to the number of calculations that would be done without such control elements).

Note also that control elements of different types can be employed, depending upon the particular application.

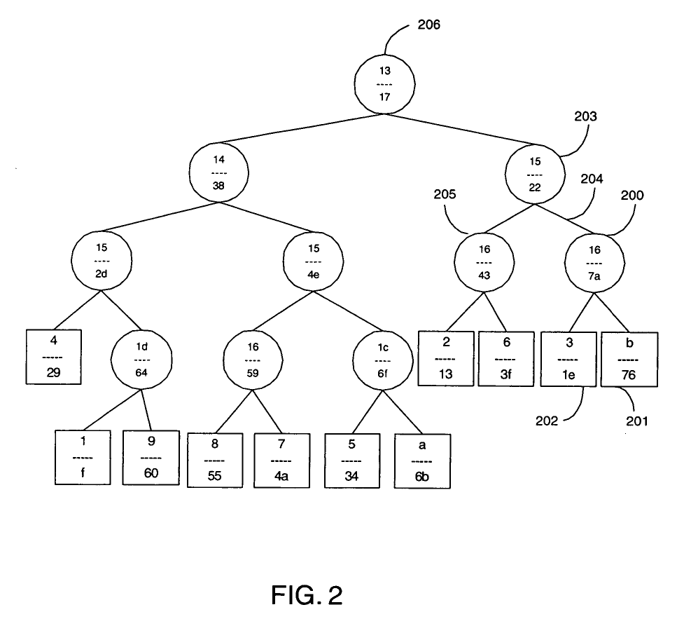

FIG. 2 shows the structure of the trie of FIG. 1 after an insertion of a new designated key (with the value “Volvo” after the designator).

The tree was updated by the additional nodes 200 and 201 of FIG. 2. More specifically, the update of the trie of FIG. 1 by inserting a new key whose designator is 0x00 (first byte) and 0x01 (second byte) and the key after the designator is “Volvo” results in the trie of FIG. 2, whereas the node 200 (node value 0x16) differentiate between the key 0x00 0x01 “Thing” (202) and the new key (201). In FIG. 1, node 112 has right child 122. In FIG. 2, node 203 corresponds to node 112 and after the update, a new node 200 is added as a right child of 203 and a new leaf node 201 as a right child of 200. The left child of 200 (202) is the original right child (122) of node 112 in FIG. 1.

As shown, node 200 is a non-leaf node with the value 0x16, stored at position 0x7a. Node 201 is a leaf node representing the new key with its logical number 0xb. The information relating node 201 is stored from position 0x76 in the block or memory page that accommodate the trie.

According to the prior art, FIG. 3A shows the original pointerless implementation (before the update to represent the new key) as demonstrated above.

After the insertion, a pointerless representation of the trie of FIG. 2 can be of the format shown in FIG. 3B (for both FIGS.—3A and 3B, the line breaks, the line numbers, the spaces and the stars between the elements are for convenience only and in practice, each structure is maintained as a single consecutive string of bits).

It should be noted that the update of the tree structure involved repositioning many of the nodes in the trie. For example, layer 4 of the tree had 6 elements before the update (line 4 of FIG. 3A), whereas after the update, layer 4 includes 8 elements (line 4 of FIG. 3B) as node 202 of FIG. 2 was pushed from layer 3 (before the update) to layer 4 and node 201 was added.

Since in practice and as explained, the trie information is set sequentially as a string of bits, the additional two nodes of layer 4 generated a shift in the position of all the nodes of layer 5. Thus, the update of the trie structure implementation shown in FIG. 3A, included a shift in the position of all the nodes of line 5 in FIG. 3A, to allow storage place in the sequence of bits, to the additional nodes 301 and 302 of FIG. 3B.

With large tries, this process may not be efficient, as shifts in the position of many nodes may happened. In these implementation examples, the lower (closer to the root) the layer being updated, more nodes are shifted. If a new root is added, all the existing nodes in that particular trie may be shifted.

Delete may affect the performance in a similar manner. If node 201 of FIG. 2 is being deleted (for example as the result of deleting the key Volvo), the trie returns to its original structure as shown in FIG. 1 (when node 201 is deleted, the parent node 200 is deleted as well to maintain the PT structure) and may be implemented by the pointerless implementation shown in FIG. 3A. Thus layer 4 shrinks from 8 elements to 6, which may trigger a shift in the position of the elements in layer 5.

In accordance with certain other embodiments, in order to overcome the shifts in the positions of nodes, new control elements are introduced. In accordance with a non-limiting implementation, these control elements address an auxiliary structure that, together with the original pointerless representation, reflects the structure of the trie including the changes. The auxiliary structure obviates the need to shift nodes (such as the nodes of layer 5 in the above example), as a result, the update process of such pointerless trie may be more efficient in terms of update time. This stems from the fact that the updates are local and there is no need to massive shifts in the positions of nodes.

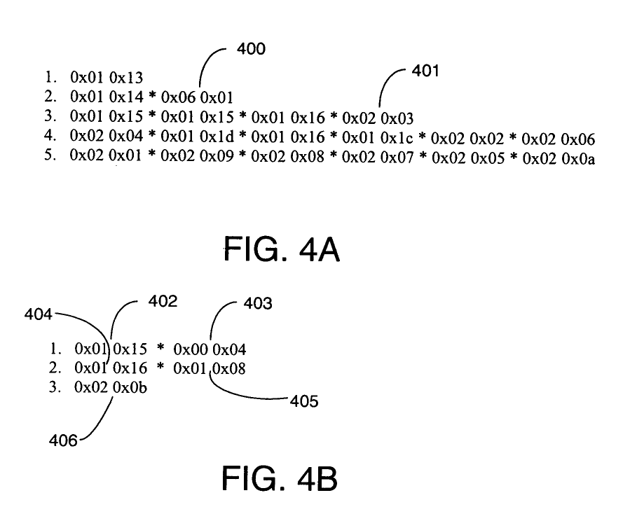

FIGS. 4A and 4B show an example of such implementation. FIGS. 4A and 4B (like FIG. 3B) form a structure reflecting the trie of FIG. 2. However, an update procedure that utilizes the structure of FIGS. 4A and 4B does not entail massive shifts.

As explained before, the update of the trie resulted from the insertion of the new key. The insertion of the key created the new nodes 200 and 201 of FIG. 2. Thus, the changes made to the trie are: the right link of node 203 (link 204) is connected to a new non-leaf node (node 200), the new non-leaf node (200) is connected by a left link to element 202 and by a right link to new leaf element 201 (that contains the id of the new data element).

These changes are being represented in an auxiliary structure as a connected trie that is implemented with pointers as shown in FIG. 4B. These pointers address other elements in the auxiliary structure or elements in the original pointerless trie. A traversal is able to shift from the pointerless trie to the auxiliary structure and from the auxiliary structure to the pointerless trie as the two structures form together the complete trie (including all the changes).

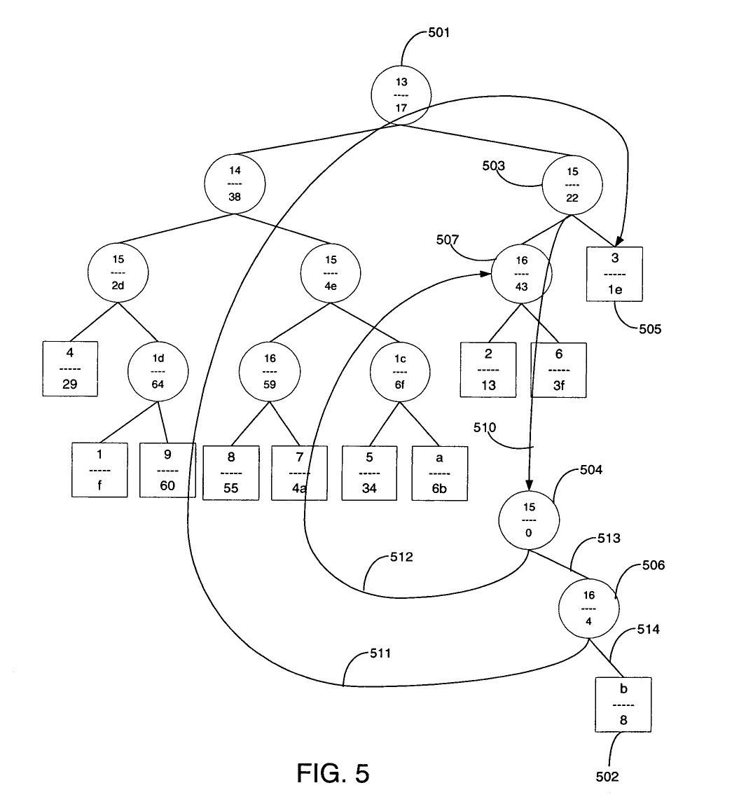

FIG. 5 shows the logical relationship between the pointerless trie of FIG. 4A and the auxiliary structure of FIG. 4B. As will be explained in greater detail below, FIG. 5 includes the original nodes of FIG. 1, and the nodes (504, 506 and 502) that were inserted and/or affected by the insert. The latter nodes correspond to nodes 203, 200 and 201 in FIG. 2.

The trie of FIG. 4B is the auxiliary structure that, together with the pointerless trie of FIG. 4A, maintains a complete trie including the updates. In this example, the auxiliary structure in FIG. 4B includes all the nodes that were affected (or added) by the update process. Therefore, the auxiliary structure of FIG. 4B includes nodes 504, 506 and 502 of FIG. 5 (corresponding to 203, 200 and 201 of FIG. 2). Within the auxiliary structure, node 504 is duplicating node 503 and is pointing by the left link (512) to node 507 in the original pointerless trie (corresponding to the pointing of node 203 to 205 in FIG. 2), and by a right link (513) to node 506 (corresponding to the pointing of node 203 to 200 in FIG. 2). In the same manner, node 506 in the auxiliary structure addresses its left child 505 (202 in FIG. 2) in the pointerless trie (using pointer 511) and its right child 502 (201 in FIG. 2) in the auxiliary structure (using pointer 514).

In the original pointerless trie, node 503 (203 of FIG. 2) was replaced by a control element, directing the traversal to shift to the auxiliary structure (link 510). This will be explained in greater detail with reference to FIG. 4, below. Therefore, a search that reach node 503 is shifted to the auxiliary structure by link 510 and continues in the auxiliary structure (from node 504 to node 506 or to node 507). The traversal on the auxiliary structure can ends at a leaf node (such as node 502), or return to the pointerless trie (such as using link 512 to node 507 or link 511 to node 505).

A traversal that starts at the root node (501) and ends at the leaf 502 (from node 206 to node 201 in FIG. 2), would be directed (by the link 510 maintained in the pointerless trie) from node 503 to 504 in the auxiliary structure and continue on the auxiliary structure to node 502.

A traversal from the root node 501 to the leaf 505 (206 to 202 in FIG. 2) would be redirected from node 503 to 504 in the auxiliary structure by the link 510, and from node 506 in the auxiliary structure by its left pointer 511 to the leaf 505.

A traversal from the root node 501 to node 507 (206 to 205 in FIG. 2) (or any of its children) would be shifted by the link 510 to node 504 and by the left pointer of node 504 (marked 512) to node 507 in the pointerless trie.

There follows now a description, exemplifying navigation that utilizes the auxiliary structure of FIG. 4.

Thus, the structure of FIG. 4A represents the pointerless trie before the update. It is similar logically to the trie of FIG. 1 (and its representation in FIG. 3A). The difference between the trie of FIG. 1 and the pointerless representation of FIG. 4A is that the information for the node 112 was replaced by a control element that makes the shift to the auxiliary structure. In FIG. 3A (that shows the implementation of the trie of FIG. 1 as a pointerless trie), node 312 (0x01 0x15) was replaced by node 400 of FIG. 4A. The type 0x01 (node) was replaced by 0x06 (400) indicating a control element that is designated to redirection to the auxiliary structure. The node value is replaced to contain the identifier for the location of the auxiliary trie (0x01 in the example). Note that this update of the pointerless trie is local and does not entail the massive shifts of the nodes. This update only shows the existence (and location) of the auxiliary structure.

FIG. 4B represents the auxiliary structure. The line numbers are for convenient only showing that there are 3 elements in the structure. The star signs are for convenience to separate between the node information and the pointers information (for non-leaf nodes). Note that FIG. 4B does not employ pointerless implementation, as the intention is to make the updates of the auxiliary structure as efficient as possible in terms of update time. With the auxiliary structure of this example, each non-leaf node includes physical pointers to the locations of the immediate children.

Node 504 of FIG. 5 (203 of FIG. 2) is represented by the information in line 1 of FIG. 4B: The first values 0x01 and 0x15 (402) of line 1 represent a non-leaf node (0x01) and the node value (0x15). The next bytes (403) in line 1 (having values 0x00 and 0x04), are the pointers of the said node. Therefore, the left pointer maintains the value 0 and the right pointer maintains the value 4. In the example of FIG. 4B, the auxiliary structure uses pointers with values 0 or 1 to represent traversal shifts from the auxiliary structure to the pointerless trie. The process of navigating from the root 501 of FIG. 5 through node 503 to the auxiliary structure of the example, includes the calculations (as explained in great detail above) as to the positions (in the pointerless trie) of the immediate children of node 503. These positions are maintained during the navigation process such that it is possible to replace a pointer with the value 0 with the position of the left child 507 and the pointer with the value 1 with the position of the right child 505. Therefore, it would be possible to shift from the auxiliary structure back to the pointerless trie and continue the navigation on the pointerless trie.

Note incidentally, that in a different non-limiting implementation, these pointers include information that would identify the location to use in the pointerless trie (such as location 0x43 to use with the pointer 512 of FIG. 5).

Reverting now to FIGS. 4 and 5, the second value of 403 is 0x04 (the right pointer 513 of node 504) addressing the 4^{th} byte of the structure of FIG. 4B. The 4^{th} byte is the first byte of line number 2 of FIG. 4B (the first byte of line 1 is considered at position 0), maintaining a type 0x01 (non-leaf node) and a value 0x16 for the node value (node 404). Therefore, line number 1 of FIG. 4B represents node 504 of FIG. 5 (203 of FIG. 2) with the change in the right link to address the new node 506 (200 of FIG. 2).

The information of the new node 506 is maintained in line 2 (of FIG. 4B) such that 404 represents the node type (0x01) and node value (0x16) and 405 represent the pointer values (0x01 for the left pointer and 0x08 for the right pointer).

Since the left link maintains the value 1, the left link redirects back to the pointerless trie (to node 505). The right link 514 of node 506 (200 of FIG. 2) address the 8^{th} byte which is the first byte of line 3 creating the link to element 406 (502 of FIG. 5).

The first byte of line 3 maintains the value 0x02, meaning a leaf node (node 502 in FIG. 5) and the byte afterwards maintains a logical value from which the key can be retrieved (0x0b).

As may be recalled, FIG. 4A shows the change in the pointerless implementation. The element 400 was changed from being a non-leaf element (312 in FIG. 3A) to be a control element of type 0x06. The additional information in element 400 includes an identifier to locate the structure of FIG. 4B (0x01 in the example identifying the location of the auxiliary structure on the block).

Therefore, the layout of the pointerless trie with the changes to shift the traversal from node 503 to node 504 (using the control element 400 of FIG. 4A), together with the layout of the auxiliary structure (as explained above), represent a structure that reflect the trie of FIG. 2. For example, a process that includes traversal from the root node 206 to a leaf node 202 in FIG. 2 would be processed to follow the following nodes in FIG. 5: 501 to 503, 503 to 504 (the shift to the auxiliary structure resulting from the control element 400), 504 to 506 and 506 to 505 (using link 511). Note that the logical path from 206 to 202 in the trie of FIG. 2 was maintained in the path using the auxiliary structure. In both cases, the traversal considered the same nodes and links:

Node value 0x13, right link, node value 0x15, right link, node value 0x16, left link to element 3 (202 or 505 in FIGS. 2 and 5 respectively). The difference is that, with the process relating to FIG. 5, the navigation included shifts from the pointerless trie to the auxiliary structure and vice versa. However, these shifts are the result of the method in which the trie is implemented, but they do not change the logical structure of the trie.

Additional updates may change the existing auxiliary structure or create additional auxiliary structures. For example, an insert of a new key resulting with a new node between node 506 and 505 of FIG. 5 (a node that differentiate between the new key and the key of 505), may be added to the existing auxiliary structure such that the auxiliary structure would be modified to have a left link from node 506 to the new node and the new node would maintain a link to the new key and to element 505. Or, if the updates are to other portions of the trie (such as insertion of a new key creating a new node between nodes 101 and 107 of FIG. 1), an additional auxiliary structure may be created.

The result is that changes in the pointerless trie, are reflected in the auxiliary structure. The navigation process shifts from one structure to another, such that the trie with the changes is represented. Updates to the trie are fast as both the pointerless trie and the auxiliary structure can be maintained in the same block and the shifts of the nodes in the pointerless trie are avoided. This stems inter alia from the facts that with the auxiliary structure, the updates trigger changes similar to the logical changes of the tree, whereas the updates of a pointerless trie without the auxiliary structure, triggered changes to portions of the trie that were not related to the logical changes (such as the shifts of the nodes to reorganize the structure of the trie to reflect the update).

Obviously, any change to the tree can be reflected by an auxiliary structure and there could be many auxiliary structures to complement a pointerless structure. For instance, each update may be reflected in a different auxiliary structure. This, however, is by no means binding.

As exemplified above, the use of the auxiliary structure makes the update of a pointerless implementation more efficient. With a pointer based trie, updates are local, hence updates affect only few nodes that are logically affected by the update. The massive shifts that are needed to update a pointerless trie are avoided. U.S. Pat. No. 6,175,835 demonstrated the use of tries in disk based blocks: If a pointerless trie was to be implemented in each block, the overall size of the index would be smaller, but one could assume that, on average, about half of the information in each block (that is being updated) is shifted to support every update. Therefore, it would be advantageous to include for each block with a pointerless trie, one or more auxiliary structures to reflect the changes. With multiple updates the growth of the auxiliary structures and the additional auxiliary structures would make the blocks full. It should be also noted that, if the auxiliary structures are implemented, such that the non-leaf nodes include the pointers that represent the relations between the nodes, the updates to the trie are implemented using more block space than if the updates were done directly on the pointerless trie (hence the pointers are not physically maintained in the pointerless implementation). For example, the trie of FIG. 2 is represented using 21 elements by the pointerless trie of FIG. 3B and using 24 elements by the pointerless trie of FIG. 4A together with the auxiliary structure of FIG. 4B

As explained in the above patent, when a block is full, it is being split. However, with the auxiliary structures, once a block is full, a new pointerless trie structure is built. The new pointerless structure reflects the trie with all the changes of the auxiliary structures. If the size of the new pointerless trie within the block allows (in terms of available space in the block) for additional update (or updates) to be represented by new auxiliary structure (or structures), then, the block maintains the new pointerless trie and is not split. However, if after the creation of the new pointerless trie, the available space in the block is not sufficient to include new auxiliary structure (or structures), the block is being split. The amount of the needed block space (after the creation of the new ponterless trie) depends on each specific implementation.

With a mechanism using auxiliary structures, it is possible to delay the split by rebuilding a new compressed (pointerless) trie that includes all the updates reflected by the auxiliary structures. This process is usually done once for multiple updates whenever the size of the pointerless trie and the size of all the (one or more) auxiliary structures is greater than a certain limit. The new pointerless structure is more compact than the original pointerless trie with the auxiliary structures. However, the expensive compression process of building the new pointerless trie (e.g. from the representation of FIGS. 4A and 4 B to the representation of FIG. 3B) can be done once for multiple updates and therefore its effect on the overall processing time was smaller than a compression process that is triggered after every update (as is the case in the prior art, as exemplified e.g. in the update procedure effected on the pointless data structure of FIG. 3A and resulted in the updated version of FIG. 3B). With a mechanism that uses pointerless tries and auxiliary structures, a block split would be done when a new pointerless trie is built (reflecting all the updates) and its size is greater than a certain limit. Therefore, the process of updating a pointerless trie stored in a disk block (or a memory page), includes reflecting changes to the trie with auxiliary structures. If the auxiliary structures are stored in the same disk block (or memory page) together with the original pointerless representation of the trie, when the disk block (or memory page) is full, a new pointerless trie can be created. This new pointerless trie reflects the original trie with the relevant changes (as maintained in the auxiliary structures).

The new pointerless representation replaces the original pointerless implementation and the auxiliary structures and may be more efficient in terms of storage space (than the storage space of the original pointerless implementation and the one or more added auxiliary structures).

Thus, if the buildup of the new pointerless implementation is done once for multiple updates (that are reflected in one or more auxiliary structures), the shifts of nodes to create the new pointerless implementations are done once for multiple updates of the trie, rather than once for every update of the trie. Thus, the method described above may be more efficient than creating a pointerless trie after every update. In addition, the overall size of the index remains small and compressed as block splits are done only when a compressed (pointerless) trie has fully grown within the index block.

Obviously, there are many ways to implement auxiliary structures and the method exemplified above is only by a way of a non-limiting example.

In addition, the type and size of the elements can change and vary in different implementations.

The present invention has been described with a certain degree of particularity, but those versed in the art will readily appreciate that various alterations and modifications can be carried out without departing from the scope of the following claims:

1. A computer program product that includes a pointerless binary trie structure; said trie structure includes elements representative of nodes of the trie; the structure further includes control elements that maintain information that facilitate traversal using the trie in a more efficient manner, compared to traversal using a pointerless binary trie structure that is devoid of the control elements.

2. The product of claim 1 wherein the trie is constructed in layers, and wherein control elements include information on the number of node elements in each layer of the trie.

3. The product of claim 2, wherein each control element is located as a first element in a succession of node elements in each layer.

4. The product of claim 1 wherein each control element includes information on the location of the next control element.

5. The product of claim 1 wherein control elements are identified by their type.

6. The product of claim 1 wherein control elements include information on the number of children that at least one element disposed between the control element and the next control element have.

7. The product of claim 1, wherein said trie structure represents a PATRICIA trie structure.

8. In a pointerless binary trie structure that includes node elements representative of nodes of the trie, a method for traversing the trie, comprising:
a. incorporating control elements in the trie;
b. traversing the trie using the control elements, thereby reducing the number of nodes that are visited compared to the number of nodes that need to be visited had pointerless binary trie structure that is devoid of control elements been used.

9. A computer program product that includes a pointerless binary trie structure; said binary trie structure includes node elements representative of nodes of the trie; said trie structure includes at least one control element that includes information that address at least one auxiliary structure; said auxiliary structure, together with an original pointerless implementation, reflect the structure of the original trie after having been subjected to one or more updates.

10. The product of claim 9, wherein said update includes insertion of at least one node or deletion of at least one node.

11. The product of claim 9, wherein said auxiliary structure is implemented as a binary Patricia trie with pointers.

12. A computer program product that includes pointerless implementation of a binary trie; updates to the said trie are reflected by one or more auxiliary structures; if a disk block or memory page that stores the pointerless implementation together with the one or more auxiliary structures is full, a new pointerless trie is created; said new pointerless trie reflects the original trie with the relevant changes.

13. The product of claim 12 wherein the said new pointerless trie replaces an original trie and the (one or more) auxiliary structures.

14. A computer program product that includes an index over keys of data records; said index is implemented based on a pointerless binary Patricia trie structure; said index includes an auxiliary structure that reflects updates to said index; said auxiliary structure is implemented with pointers.

15. A computer program product that includes an index; the internal structure of the blocks of the said index is based on binary Patricia tries; the implementation of the trie within one or more blocks is of a pointerless trie; said pointerless trie includes control elements.

16. The product of claim 15 wherein the control elements allow efficient traversal compared to an implementation of the trie that does not use control elements.

17. The product of claim 15 wherein at least one control elements maintain the number of elements in each layer of the tree.

18. The product of claim 15 wherein said index is a layered index.

19. The product of claim 15 wherein said trie includes at least one control element that addresses an auxiliary structure; said auxiliary structure reflects updates to said index.

20. A method for navigating in a binary Patricia trie; said trie is implemented as a pointerless trie; said pointerless trie includes one or more control elements; said control elements maintain information being used in the navigation process for efficiency.

21. In a pointerless binary Patricia trie structure that includes elements representative of nodes in the trie, a method for traversing the trie, comprising:
a. incorporating control elements in the trie;
b. traversing the trie using the control elements thereby reducing the number of nodes that are visited compared to the number of nodes that need to be visited using pointerless binary Patricia trie structure that is devoid of control elements.

22. A computer program product that includes a pointerless binary Patricia trie structure; said trie structure includes elements representative of nodes of the trie; said trie structure includes at least one control element that included information that addresses respective auxiliary structures; said trie structure, together with the auxiliary structures, reflect the logical structure of the trie including the updates.

23. A computer program product that includes a pointerless binary trie, said trie includes control elements; said control elements include additional information; said additional information obviates calculations that are performed during traversal of a pointerless binary trie without control elements.

24. The product of claim 23, wherein said trie structure represents a PATRICIA trie structure.
